(19) United States
(12) Patent Application Publication
(10) Pub. No.: US 2015/0267643 A1
(43) Pub. Date: Sep. 24, 2015

(54) THRUST REVERSER WITH PIVOTING CASCADES

(71) Applicant: AIRCELLE, GONFREVILLE L'ORCHER (FR)

(72) Inventors: Patrick GONIDEC, Bretx (FR); Laurent Albert Blin, Sainte Adresse (FR); Olivier Kerbler, Antony (FR)

(21) Appl. No.: 14/464,649

(22) Filed: Aug. 20, 2014

Related U.S. Application Data
(63) Continuation of application No. PCT/FR2013/050289, filed on Feb. 13, 2013.

(30) Foreign Application Priority Data
Feb. 22, 2012 (FR) 12/51605

(51) Int. Cl. F02K 1/72

(52) U.S. Cl. CPC F02K 1/72

(57) ABSTRACT

A cascade-type thrust reverser for an aircraft turbojet engine includes a front frame, a sliding cowl between a direct jet position and a reverse jet position, a plurality of actuating cylinders interposed between this front frame and this sliding cowl, and a plurality of cascades pivotally mounted on the front frame between the direct and reverse jet positions. In the direct jet position, the cascades are substantially parallel to the axis (A) of the thrust reverser, and in the reverse jet position, the cascades are inclined relative to the axis (A) of the thrust reverser. In particular, the cascade-type thrust reverser includes a single radial layer of cascades.

### CROSS-REFERENCE TO RELATED APPLICATIONS

This application is a continuation of International Application No. PCT/FR2013/050289, filed on Feb. 13, 2013, which claims the benefit of FR 12/51605, filed on Feb. 22, 2012. The disclosures of the above applications are incorporated herein by reference.

### FIELD

The present disclosure relates to a cascade-type thrust reverser for an aircraft turbojet engine, and to a nacelle for an aircraft turbojet engine equipped with such a thrust reverser.

### BACKGROUND

The statements in this section merely provide background information related to the present disclosure and may not constitute prior art.

A nacelle for an aircraft turbojet engine constitutes the aerodynamic fairing of this turbojet engine, and furthermore allows fulfilling many functions, among which the thrust reversal function when it is equipped with a thrust reverser.

Such a thrust reverser allows, when the aircraft lands, diverting upstream of the nacelle at least part of the airflow generated by the turbojet engine (configuration called “reverse jet”), and thus actively contributing to the braking of the aircraft, thereby reducing the distance necessary for it to reach a complete stop.

In the prior art, there are two main categories of thrust reversers: the door-type thrust reversers, and the cascade-type thrust reversers.

In the thrust reversers of the first category, the deflection of the airflow is generated by doors which open outward of the nacelle.

In the thrust reversers of the second category, the deflection of the airflow is generated by thrust reversal flaps which hinder the normal air flow inside the nacelle, and return it upstream of the nacelle through cascades disposed at the periphery of the nacelle, which are uncovered by downstream sliding of a downstream part of the nacelle, often called sliding cowl.

In the cascade-type thrust reversers, we must thus provide a mechanics of thrust reversal flaps which in practice are actuated by rods which, during normal operation (configuration called “direct jet”) extend across the cold air flow of the turbojet engine.

This mechanics is relatively heavy, and in addition it necessarily results in a significant loss of acoustically treated surface and a loss of thrust caused by the interference of the rods of the thrust reversal flaps with the cold air flow of the turbojet engine and by the geometrical singularities induced by the flaps and their housing in the sliding cowl of the thrust reverser.

Attempts have been made in the state of the art to improve the cascade-type thrust reversers by masking the flaps in direct jet.

It is known for example from document U.S. Pat. No. 3,981,451 a cascade-type thrust reverser comprising, on the one hand, fixed radially outer cascades, and on the other hand, radially inner cascades pivotally mounted between a direct jet position, in which they do not interfere with the cold air flow of the turbojet, and a reverse jet position, in which they are inclined inward of the nacelle, and thus allowing diverting the cold flow toward the radially outer cascades, and therefore outward and upstream of the nacelle.

This device of the state of the art is interesting in that it allows eliminating the presence of thrust reversal flaps, and the presence of rods relating to it in the direct jet flow.

However, it has a number of drawbacks, including:
the high radial encumbrance, inherent to the superposition of the radially outer and inner cascades, and
the extra complexity and weight, generated by the need to provide an actuating cylinder for each radially inner cascade.

### SUMMARY

The present disclosure provides a cascade-type thrust reverser for aircraft turbojet engine, comprising a front frame, a sliding cowl between a direct jet position and a reverse jet position, a plurality of actuating cylinders interposed between this front frame and this sliding cowl, and a plurality of cascades pivotally mounted on the front frame between a direct jet position in which the cascades are substantially parallel to the axis of the thrust reverser, and a reverse jet position in which the cascades are inclined relative to the axis of the thrust reverser, characterized in that it comprises a single radial layer of cascades.

This thrust reverser therefore no longer comprises in particular layers of fixed cascades superposed on the pivoting cascades, unlike what is disclosed by U.S. Pat. No. 3,981,451.

We obtain in this way relatively low radial encumbrance, and a reduced overall weight.

In accordance with other features of the thrust reverser according to the present disclosure:
said cylinders each comprise a first actuating bar cooperating with said sliding cowl, and a second actuating bar cooperating with actuating means of said pivoting cascades: the use of such double acting cylinders allows limiting the number of cylinders and the encumbrance, while satisfying the needs for moving the sliding cowl, on the one hand, and the cascades, on the other hand;
said actuating means of the cascades comprise at least a sliding annular panel, to which are connected, on the one hand, said second actuating bars, and the other hand, the rods connected at their other end to each pivoting cascade: in this way, translating the annular panel by the second actuating bars of the cylinders, allows pivoting all of the cascades in concert; moreover, this annular panel allows limiting the air leakages of the cold air flow path of the nacelle outwardly during the transition phases of the thrust reverser between the direct jet and reverse jet configurations;
said annular panel is disposed in the extension of the outer skin of the sliding cowl: this form allows a substantial weight gain, since an outer skin extending axially over a shorter length can be made;
said annular panel comprises a return forming a bib, so as to contribute to the reduction of unwanted air flow bypassing the downstream edge of this annular panel;
said pivoting cascades have a contour of substantially trapezoidal shape: this particular shape allows disposing the points of connection of the first actuating bars of the cylinders with the sliding cowl, between the pivoting cascades; in this way the radial encumbrance of the assembly can be further reduced;
the thrust reverser comprises additional cascades mounted in a bent manner on said pivoting cascades, so that in the reversed jet position, said additional cascades are oriented substantially parallel to the axis of the thrust reverser.

The present disclosure also relates to a nacelle for an aircraft turbojet engine, characterized in that it is equipped with a thrust reverser in accordance with the foregoing.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an axial section view of half of the thrust reverser according to the present disclosure;

FIG. 2 is a partial view of this thrust reverser, taken according to the arrow II of FIG. 1;

FIG. 3 is a view similar to the one of FIG. 1, the thrust reverser is being deployed toward its reverse jet position;

FIG. 4 is a view similar to that of FIGS. 1 and 3, the thrust reverser being in the reverse jet position;

FIGS. 5 and 6 show the thrust reverser of the preceding figures in two alternatives of maintenance configurations;

FIGS. 7 to 9 show another form of a thrust reverser according to the present disclosure, in configurations similar to those of FIGS. 1, 3 and 4 respectively; and

FIGS. 10 to 12 show yet another form of a thrust reverser according to the present disclosure, in configurations similar to those of FIGS. 1, 3 and 4 respectively.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Also note that the air flow intended to cross the nacelle of which is part the shown thrust reverser, flows in operation from upstream to downstream of the nacelle, that is to say from left to the right of all the attached figures.

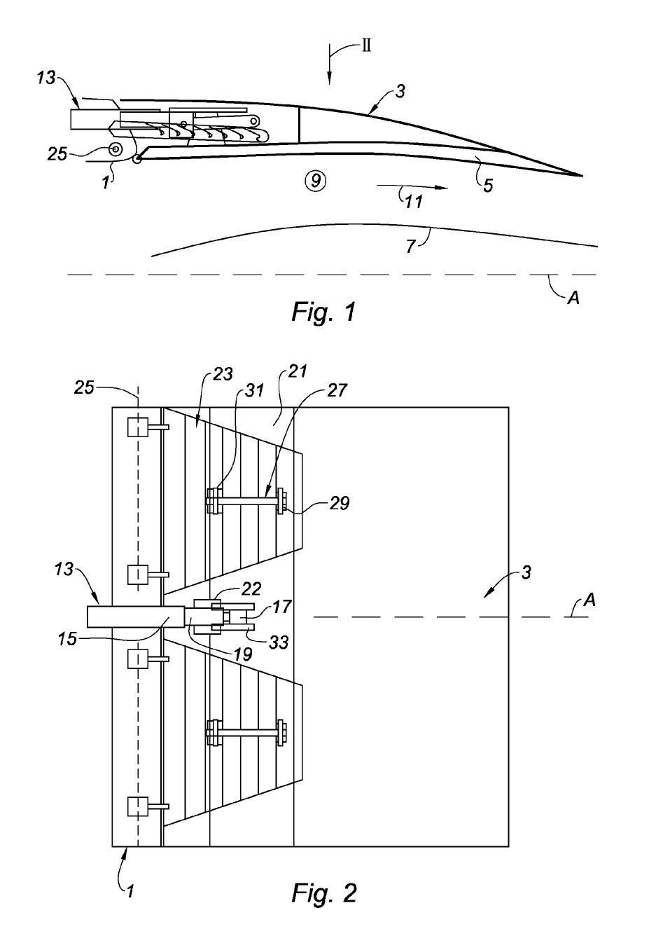

Referring now to FIGS. 1 and 2, on which it can be seen that the thrust reverser according to the present disclosure comprises a fixed front frame 1, integral with the fixed structure of the nacelle or integrated to the casing of the engine fan, as well as a cowl 3, slidingly mounted relative to this fixed structure, for example, on rails located on the upper (commonly called “12h”) and lower (commonly called “6h”) beams of the nacelle.

On its inner surface, the sliding cowl 3 includes a coating 5 having acoustic absorption properties, capable of being formed in particular from the honeycomb structure covered with a perforated skin.

The sliding cowl 3 defines, with a fairing 7 surrounding the turbojet engine (not shown), a cold air flow path 9, flowing in the direction of the arrow 11, and providing most of the thrust force of the propulsive assembly formed by the nacelle and its turbojet engine.

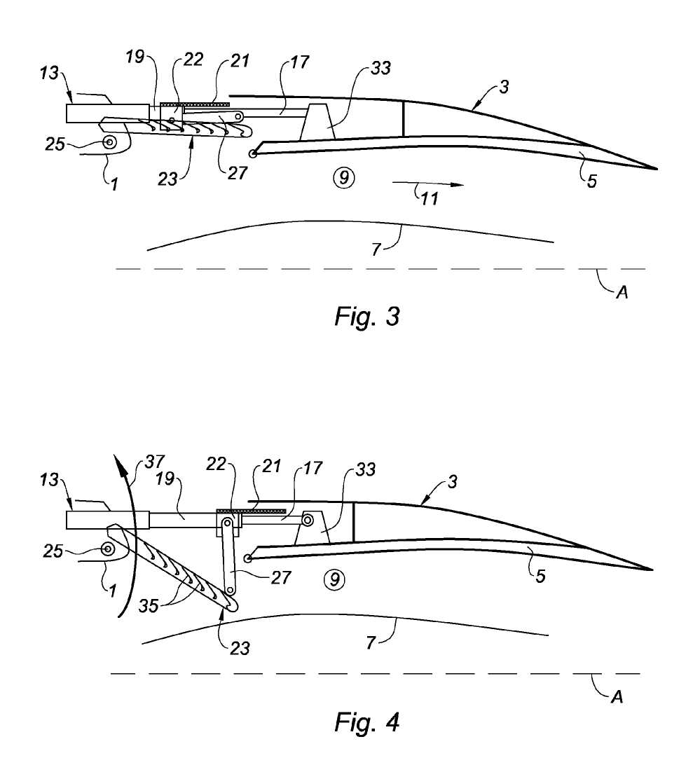

The translational movement of the sliding cowl 3 between its position shown in FIGS. 1 and 2, and its positions shown in FIGS. 3 and 4, is carried out by a plurality of cylinders 13 distributed at the periphery of the thrust reverser, interposed between the front frame 1 and the sliding cowl 3.

More specifically, as it can be seen in particular in FIG. 2, each cylinder 13 includes a hollow cylindrical body 15 integral with the front frame 1, as well as the first 17 and second 19 actuating bars respectively cooperating with the sliding cowl 3 and with a mechanism which will be described hereinafter.

In other words, each cylinder 13 is a telescopic double bar cylinder, the extension movements of each of these two bars being studied to obtain the desired kinematics.

These cylinders can be driven by hydraulic or electric motors, and the extension movement of each bar can be provided for example through mechanisms of the nut and the ball screw types, conventionally used in the field of aeronautics.

To return to the aforementioned mechanism, the second bars 19 of each cylinder 13 cooperate with an annular panel 21, to which they are connected by fittings 22.

Thrust reversal cascades, having a contour of substantially trapezoidal shape as it can be seen in particular in FIG. 2, are each pivotally mounted around an axis 25, on the front frame 1.

Rods 27 are pivotally mounted at each of their ends 29 and 31, respectively on the annular panel 21 and an associated pivoting thrust reversal cascade 23.

The first actuating bar 17 of each cylinder 13 is connected to the sliding cowl 3 by a suitable fitting 33.

The operating mode of the thrust reverser which has just been described will be clearly understood by examining FIGS. 3 and 4.

First of all, the operating mode starts by extending the first actuating bar 17 of each cylinder 13, as seen in FIG. 3.

In doing so, the sliding cowl 3 moves toward a deployed position, in which it uncovers the annular panel 21 and the mechanisms of rods 27 and pivoting cascades 23.

During this transitional phase, the second actuating bar 19 remains retracted, and the annular panel 21 prevents air flowing inside the cold air flow path 9 from exiting outward of the nacelle.

This is followed by the extension of the second actuating bar 19, as seen in FIG. 4.

In doing so, the cascades 23 pivot each around their respective axes 25, under the effect of the rods 27 driven by the displacement of the annular panel 21.

The pivoting reverser cascades 23 thus reach the position visible in FIG. 4, in which they are inclined relative to the axis A of the nacelle and obstruct the cold air flow path 11.

Thanks to their properly oriented fins 35, the reverser cascades 23 allow diverting the major part of the cold air flow flowing inside of the flow path 9 outward and upstream of the nacelle, as it is indicated by the arrow 37 of FIG. 4.

Note that the extension of the second actuating bar 19 has the effect of sliding the annular panel 21 to a downstream position visible in FIG. 4, in which it allows the passage of the diverted flow 37.

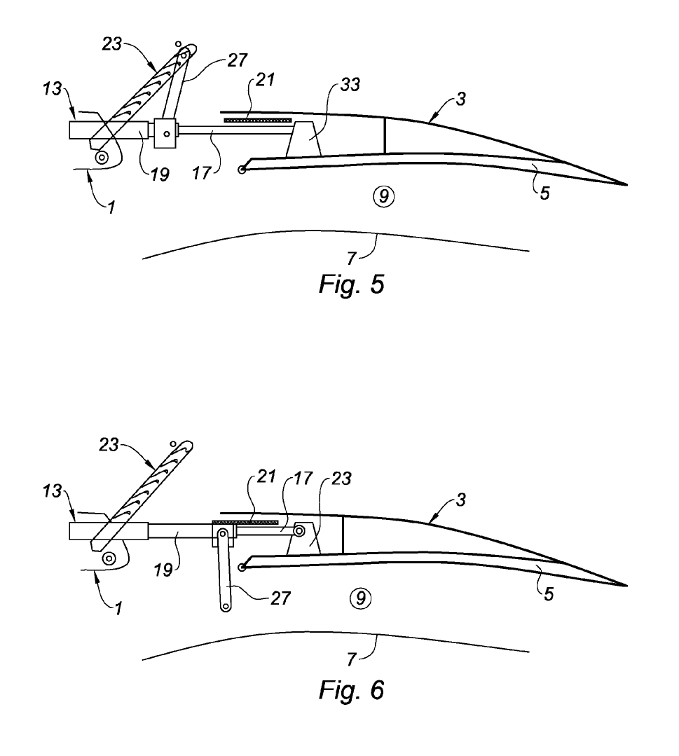

For maintenance operations of the cascades 23, it is possible, according to a first alternative shown in FIG. 5, to start by bringing the first bars 17 in their extended position so as to slide the cowl 3 to its downstream position (corresponding to its reversed jet position), then disconnect the second actuating bars 19 and the rods 27 of the annular panel 21, then slide the annular panel to its downstream position, then pivot the cascades 23 (and the rods 27 which remained gripped to them) outward of the nacelle.

According to a second alternative shown in FIG. 6, it is possible to start by bringing the first 17 and second 19 bars in their extended position (which has the effect of bringing the annular panel 21 toward its downstream positron), then disconnect the rods 27 of cascades 23, and pivot the cascades 23 outward of the nacelle.

As can be understood in the light of the foregoing description, the thrust reverser with pivoting cascades according to the present disclosure is of a simple design, and allows carrying out the thrust reversal function with a single radial layer of cascades, contrary to the state of the art.

This results in a small radial encumbrance, allowing in particular a complete acoustic treatment of the entire inner surface 5 of the sliding cowl 3.

The trapezoidal shape (narrowing downstream) of the thrust reversal cascades 23 allows the positioning of the cylinders 13 and fittings 22 and 33 between these cascades, contributing thus to the limitation of the radial encumbrance of the assembly.

Besides, note that the device according to the present disclosure allows eliminating any support rear frames of the thrust reversal cascades, contrary to conventional systems with fixed cascades.

Furthermore, note that counter-thrust forces are taken almost entirely by the front frame 1, and that the radial forces are taken by the annular panel 21, in the reverse jet configuration.

The present disclosure therefore provides a particularly simple design system, involving a limited number of parts, of a relatively low overall weight, and allowing removal in an elegant manner of the thrust reversal flaps and the associated rods of the thrust reverser conventional systems with fixed cascades.

Of course, the present disclosure is not limited to the described and shown forms, provided as simple examples.

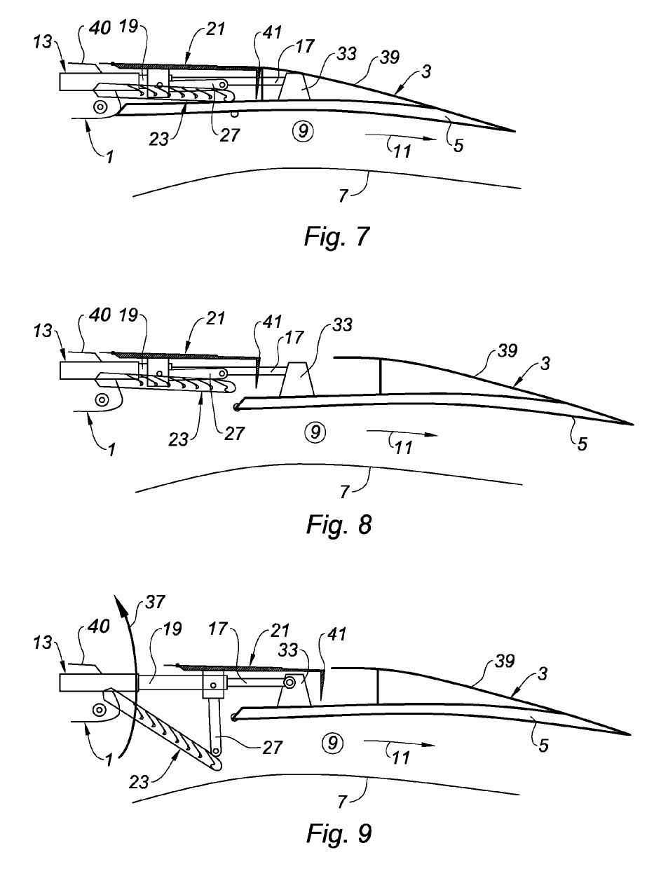

Thus, for example, we may consider the form of FIGS. 7 to 9, wherein the annular panel 21 is disposed in the extension of the outer skin 39 of the sliding cowl 3.

In this form, when the thrust reverser is in the direct jet configuration (FIG. 7), the annular panel 21 thus carries out the junction between the outer skin 40 of the fixed part of the nacelle, and the outer skin 39 the sliding cowl 3.

This form allows a substantial weight gain, since an outer skin 39 extending axially over a shorter length can be made.

Moreover, the greatest axial length of the annular panel 21 with respect to that of the annular panel of the foregoing form, allows limiting the air flow passing through the cascades 23 when the thrust reverser is in the intermediate situation (FIG. 8), that is to say between its direct jet and reverse jet positions.

It is advantageously anticipated that the annular panel 21 comprises a return 41 forming a bib, so as to contribute to the reduction of unwanted air flow bypassing the downstream edge of this annular panel.

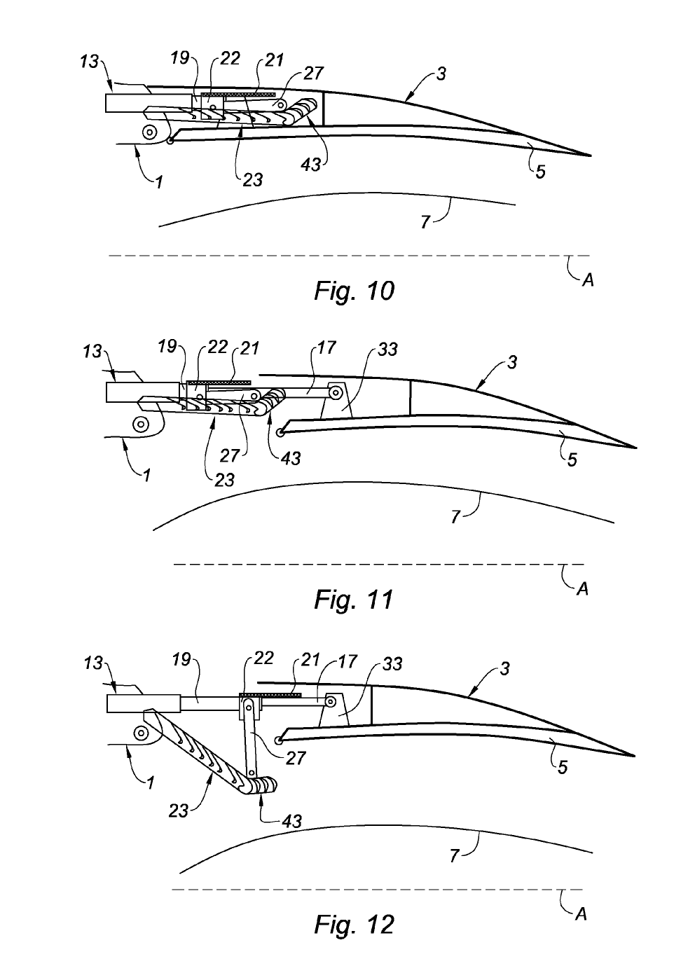

This is how we can also consider that the form of FIGS. 10 to 12, wherein it is provided additional cascades 43 mounted downstream of the pivoting thrust reversal cascades 23.

Additional cascades 43 form an elbow with the cascades 23, so that in reverse jet (FIG. 12) these additional cascades are substantially aligned with the leakage flow passing between these additional cascades 43 and the fairing 7, that is to say substantially parallel to the axis A of the thrust reverser.

These additional cascades 43 allow redirecting outward of the nacelle part of this leakage flow and thus contributing to the counter-thrust in reverse jet without excessively obstructing the flow path 9.

What is claimed is:

1. A cascade-type thrust reverser for an aircraft turbojet engine, comprising:
a front frame;
a sliding cowl between a direct jet position and a reverse jet position;
a plurality of actuating cylinders interposed between the front frame and the sliding cowl; and
a plurality of cascades pivotally mounted on the front frame between the direct jet position, in which the cascades are substantially parallel to an axis of the thrust reverser, and the reverse jet position, in which the cascades are inclined relative to the axis of the thrust reverser,
wherein the thrust reverser comprises a single radial layer of cascades.

2. The cascade-type thrust reverser according to claim 1, wherein said actuating cylinders each comprise a first actuating bar cooperating with said sliding cowl, and a second actuating bar cooperating with actuating means of the cascades.

3. The cascade-type thrust reverser according to claim 2, wherein said actuating means of the cascades comprise at least one sliding annular panel to which are connected said second actuating bars and rods at an end thereof, the rods being connected at the other end to each pivoting cascade.

4. The cascade-type thrust reverser according to claim 3, wherein the rods are pivotally mounted, at each of the ends, on the at least one sliding annular panel and the cascade.

5. The cascade-type thrust reverser according to claim 3, wherein an extension of said second actuating bars is configured to slide the at least one sliding annular panel to a downstream position in which a cold air flow is diverted through the cascades.

6. The cascade-type thrust reverser according to claim 3, wherein said annular panel is disposed in an extension of an outer skin of the sliding cowl.

7. The cascade-type thrust reverser according to claim 6, wherein the at least one sliding annular panel is configured to carry out a junction between an outer skin of the front frame and the outer skin the sliding cowl.

8. The cascade-type thrust reverser according to claim 6, wherein said annular panel comprises a return forming a bib.

9. The cascade-type thrust reverser according to claim 1, wherein the cascades have a contour of substantially trapezoidal shape.

10. The cascade-type thrust reverser according to claim 1, further comprising additional cascades mounted in a bent manner on the cascades, so that in the reverse jet position, said additional cascades are oriented substantially parallel to the axis of the thrust reverser.

11. A nacelle for an aircraft turbojet engine, wherein the nacelle is equipped with the cascade-type thrust reverser according to claim 1.
